(19) United States
(12) Patent Application Publication
(10) Pub. No.: US 2004/0038140 A1
(43) Pub. Date: Feb. 26, 2004

(54) Benzophenone bisimide malononitrile derivatives

(75) Inventors: James M. Duff, Mississauga (CA); John F. Graham, Oakville (CA); Timothy P. Bender, Port Credit (CA); Yvan Gagnon, Mississauga (CA); Andronique Ioannidis, Webster, NY (US)

Correspondence Address: Patent Documentation Center, Xerox Corporation, Xerox Square 20th Floor, 100 Clinton Ave. S., Rochester, NY, 14644, US

(73) Assignee: Xerox Corporation

(21) Appl. No.: 10/225,402

(22) Filed: Aug. 20, 2002

(51) Int. Cl. G03G 5/04

(52) U.S. Cl. 430/56; 430/78; 430/58.5; 548/406; 548/455

(57) ABSTRACT

A compound having the Formula I

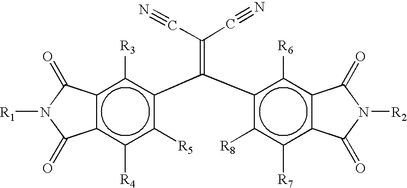

wherein:

R₁ and R₂ are independently selected from the group consisting of hydrogen, a hetero atom containing group and a hydrocarbon group that is optionally substituted at least once with a hetero atom moiety; and

R₃, R₄, R₅, R₆, R₇, and R₈ are independently selected from the group consisting of a nitrogen containing group, a sulfur containing group, a hydroxyl group, a silicon containing group, hydrogen, a halogen, a hetero atom containing group and a hydrocarbon group that is optionally substituted at least once with a hetero atom moiety.

### BACKGROUND OF THE INVENTION

Many electrophotographic elements currently in use are designed to be initially charged with a negative polarity. Such elements contain material which facilitates the migration of positive holes toward the negatively charged surface in imagewise exposed areas in order to cause imagewise discharge. Such material is often referred to as a hole-transport agent. In elements of that type, a positively charged toner material is usually then used to develop the remaining imagewise undischarged areas of negative polarity potential, i.e., the latent image, into a toner image. Because of the wide use of negatively charging elements, considerable numbers and types of positively charging toners have been fashioned and are available for use in electrophotographic developers.

However, for some applications of electrophotography it is more desirable to be able to develop the surface areas of the element that have been imagewise exposed to actinic radiation, rather than those that remain imagewise unexposed. For example, in laser printing of alphanumeric characters it is more desirable to be able to expose the relatively small percentage of surface area that will actually be developed to form visible alphanumeric toner images, rather than waste energy exposing the relatively large percentage of surface area that will constitute undeveloped background portions of the final image. In order to accomplish this while still employing widely available high quality positively charging toners, it is necessary to use an electrophotographic element that is designed to be positively charged. Positive toner can then be used to develop the exposed surface areas, which will have, after exposure and discharge, relatively negative electrostatic potential compared to the unexposed areas, where the initial positive potential will remain. An electrophotographic element designed to be initially positively charged may contain an adequate electron-transport agent, that is, a material which facilitates the migration of photogenerated electrons toward the positively charged insulative element surface.

Electrophotographic elements include both those commonly referred to as single layer or single-active-layer elements and those commonly referred to as multiactive, multilayer, or multi-active-layer elements.

Single-active-layer elements are so named because they contain only one layer that is active both to generate and to transport charges in response to exposure to actinic radiation. Such elements typically comprise at least an electrically conductive layer in electrical contact with an active layer. In single-active-layer elements, the active layer contains a charge-generation material to generate electron/hole pairs in response to actinic radiation and an electron-transport and/or hole-transport agent, which comprises one or more of chemical compounds capable of accepting electrons and/or holes generated by the charge-generation material and transporting them through the layer to effect discharge of the initially uniform electrostatic potential. The active layer is electrically insulative except when exposed to actinic radiation, and it sometimes contains an electrically insulative polymeric film-forming binder, which may itself be the charge-generating material, or it may be an additional material that is not charge-generating. In either case, the transport agent(s) is (are) dissolved or dispersed as uniformly as possible in the layer.

Multiactive elements are so named because they contain at least two active layers, at least one charge generation layer (CGL) which is capable of generating charges, i.e., electron/hole pairs, in response to exposure to actinic radiation, and at least one charge transport layer (CTL) which is capable of accepting and transporting charges generated by the charge-generation layer. Such elements typically comprise at least an electrically conductive layer, a CGL, and a CTL. Either the CGL or the CTL is in electrical contact with both the electrically conductive layer and the remaining CTL or CGL. The CGL contains at least a charge-generation material; the CTL contains at least a charge-transport agent; and either or both layers can contain an electrically insulative film-forming polymeric binder.

In multiactive positively charged photoconductor elements of the type employing at least a CGL and a CTL, the CTL may be the uppermost layer of the element to protect the more mechanically sensitive CGL from wear. Known electron transport agents may suffer from one or more problems upon repeated use, such as high dark decay, insufficient electronic charge transport activity, a gradually increasing residual potential or the like. Certain electron transport agents, such as trinitrofluorenone (TNF), which do exhibit a useful level of sensitivity, suffer from the further disadvantage that they are now suspected to be carcinogens.

Consequently, the art of photoconductor elements continues to seek new electron transport agents which exhibit sufficient sensitivity, but which do not exhibit disadvantages such as above indicated which might restrict their utilization in positively charged photoconductor elements.

Cyclic bis-dicarboximide compounds have previously been proposed for use in photoconductor elements in Gruenbaum et al., U.S. Pat. No. 5,468,583. Electron and bipolar transport are discussed in Borsenberger et al., Organic Photoreceptors for Xerography, pp. 562-569, 584-587, and 632-633 (1998).

### SUMMARY OF THE INVENTION

The present invention is accomplished in embodiments by providing a compound having the Formula I

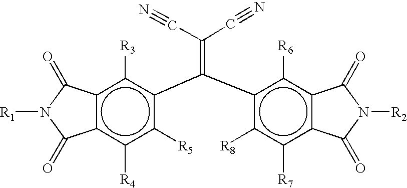

wherein:

R₁ and R₂ are independently selected from the group consisting of hydrogen, a hetero atom containing group and a hydrocarbon group that is optionally substituted at least once with a hetero atom moiety; and

R₃, R₄, R₅, R₆, R₇, and R₈ are independently selected from the group consisting of a nitrogen containing group, a sulfur containing group, a hydroxyl group, a silicon containing group, hydrogen, a halogen, a hetero atom containing group and a hydrocarbon group that is optionally substituted at least once with a hetero atom moiety.

There is also provided in embodiments a compound having the Formula I

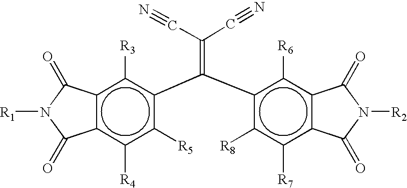

wherein:

R₁ and R₂ are independently selected from the group consisting of a straight chain alkyl group, a branched alkyl group, a cycloalkyl group, an alkoxy group, a monocyclic aromatic group, a polycyclic aromatic group, a heterocyclic group, an alkylaryl group, an arylalkyl group, an alkoxyaryl group, an arylalkoxy group, and hydrogen; and

R₃, R₄, R₅, R₆, R₇, and R₈ are independently selected from the group consisting of a straight chain alkyl group, a branched alkyl group, a cycloalkyl group, an alkoxy group, a monocyclic aromatic group, a polycyclic aromatic group, an alkylaryl group, an arylalkyl group, an alkoxyaryl group, an arylalkoxy group, an aryloxy group, a halogen, and hydrogen.

In embodiments, there is a photoconductor element comprising: a charge generation material and an electron transport agent, wherein the electron transport agent includes a compound having the Formula I.

There are further embodiments where there is a photoconductor element comprising: an electrically conductive layer; and a layer comprising a binder, a charge generation material, and an electron transport agent including a compound having the Formula I.

### DETAILED DESCRIPTION

The phrase hetero atom containing group indicates that there are present at least one other type of atom other than carbon and hydrogen within the group and that the hetero atom or hetero atoms are part of the main structural chain of the group.

The phrase hetero atom moiety indicates that there are present at least one other type of atom other than carbon and hydrogen within the group and that the hetero atom moiety is not part of the main structural chain of the group.

The term hydrocarbon refers to any moiety composed of only carbon atoms and hydrogen atoms. The hydrocarbon may be optionally substituted where one or more of the hydrogen atoms is replaced with another substituent. Furthermore, the term hydrocarbon includes for instance acyclic hydrocarbons, alicyclic hydrocarbons, aromatic hydrocarbons and the like which may be optionally substituted.

In embodiments, there is provided a compound of the Formula I

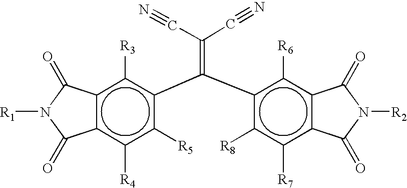

having the following substituents.

A. R₁ and R₂

R₁ and R₂ are independently selected from the group consisting of hydrogen, a hetero atom containing group and a hydrocarbon group that is optionally substituted at least once with a hetero atom moiety.

1. Exemplary Examples of the Hetero Atom Containing Group (for R₁ and R₂)

(a) an alkoxy group having for example 3 to about 30 atoms, particularly 3 to about 6 atoms such as 3-oxa-butan-1-yl, 4-methyl-3-oxapent-1-yl, an aldehyde group, and a ketone group;

(b) a heterocyclic system having for example 11 to about 30 atoms such as N-phenylcarbazol-3-yl, thiophen-2-yl, thiophen-3-yl, pyridin-2-yl, pyridin-3-yl, pyridin-4-yl, furan-2-yl, furan-3-yl and the like;

(c) an alkoxyaryl having for example 7 to about 30 atoms such as 4-methoxybenzen-1-yl and 4-ethoxybenzen-1-yl; and

(d) an arylalkoxy having for example 7 to about 30 atoms such as 3-oxa-3-phenylpropan-1-yl.

2. Exemplary Examples of the Hydrocarbon Group (for R₁ and R₂)

(a) a straight chain alkyl group having for example 1 to about 30 carbon atoms, particularly 1 to about 8 carbon atoms, such as ethanyl, butanyl or hexanyl;

(b) a branched alkyl group having for example 3 to about 30 carbon atoms, particularly 3 to about 8 carbon atoms such as 1,2-dimethylpropan-1-yl, 1-methylhexan-1-yl and 1,6-dimethylhexan-1-yl;

(c) a cycloalkyl group having for example 3 to about 20 carbon atoms, particularly 4 to about 6 carbon atoms such as cyclopentanyl and cyclohexanyl;

(d) a monocyclic aromatic group such as phenyl like benzenyl;

(e) a polycyclic aromatic group having for example 10 to about 30 carbon atoms such as naphthyl (e.g., naphthalene-1-yl and naphthalene-2-yl) and anthracen-9-yl;

(f) an alkylaryl group having for example 7 to about 30 carbon atoms such as toluen-α-yl; and

(g) an arylalkyl group having for example 7 to about 30 carbon atoms such as 4-ethylbenzen-1-yl and 4-sec-butylbenzen-1-yl.

3. Exemplary Examples of Substitutions (for R₁ and R₂)

Any of the hydrocarbon groups can be optionally substituted one, two, or more times with the same or different substituting moiety such as the following:

(a) a nitrogen containing group such as amino and nitro;

(b) a sulfur containing group such as thiol, sulfoxide, sulfate, chlorosulfate;

(c) a hydroxyl group;

(d) a silicon containing group such as a trisubstituted silane where the substituent is a hydrocarbon;

(e) a halogen such as bromine, chlorine, fluorine, and iodine; and

(f) a hetero atom moiety, having for example 3 to about 15 atoms, and including an element selected for instance from the group consisting of nitrogen, sulfur, silicon, and oxygen, such as thiophen-2-yl, thiophen-3-yl, pyridin-2-yl, pyridin-3-yl, pyridin-4-yl, furan-2-yl, furan-3-yl and the like.

Exemplary substituted hydrocarbon groups include for instance the following: 2-hydroxyethan-1-yl, 3-hydroxypropan-1-yl, 2-methylbenzen-1-yl, 2,6-diisopropylbenzen-1-yl, 2,5-dimethylbenzen-1-yl, 4-methylnapthalen-1-yl, 5-methylnaphthalen-2-yl.

B. R₃, R₄, R₅, R₆, R₇ and R₈

R₃, R₄, R₅, R₆, R₇, and R₈ are independently selected from the group consisting of a nitrogen containing group, a sulfur containing group, a hydroxyl group, a silicon containing group, hydrogen, a halogen (e.g., bromine, chlorine, fluorine, and iodine), a hetero atom containing group and a hydrocarbon group that is optionally substituted at least once with a hetero atom moiety.

1. Exemplary Examples of the Hetero Atom Containing Group (R₃ through R₈)

(a) an alkoxy group having for example 3 to about 30 atoms, particularly 3 to about 6 atoms such as 3-oxa-butan-1-yl, 4-methyl-3-oxapent-1-yl, an aldehyde group, and a ketone group;

(b) a heterocyclic system having for example 5 [symbol] to about 30 atoms such as N-phenylcarbazol-3-yl, thiophen-2-yl, thiophen-3-yl, pyridin-2-yl, pyridin-3-yl, pyridin-4-yl, furan-2-yl, furan-3-yl and the like;

(c) an alkoxyaryl having for example 7 to about 30 atoms such as 4-methoxybenzen-1-yl and 4-ethoxybenzen-1-yl; and

(d) an arylalkoxy having for example 7 to about 30 atoms such as 3-oxa-3-phenylpropan-1-yl.

(e) an aryloxy having for example 7 to about 30 atoms such as 3-methylphenoxy, 4-nonylphenoxy, 1-naphthoxy and 2-naphthoxy.

2. Exemplary Examples of the Hydrocarbon Group (R₃ Through R₈)

(a) a straight chain alkyl group having for example 1 to about 30 carbon atoms, particularly 1 to about 4 carbon atoms, such as ethanyl and butanyl;

(b) a branched alkyl group having for example 3 to about 30 carbon atoms, particularly 3 to about 4 carbon atoms such as 1-methylpropan-1-yl, 1-methylethan-1-yl and 1-methylmethan-1-yl;

(c) a cycloalkyl group having for example 3 to about 20 carbon atoms, particularly 4 to about 6 carbon atoms such as cyclopentanyl and cyclohexanyl;

(d) a monocyclic aromatic group such as phenyl like benzenyl;

(e) a polycyclic aromatic group having for example 11 to about 30 carbon atoms such as naphthyl (e.g., naphthalene-1-yl and naphthalene-2-yl) and anthracen-9-yl;

(f) an alkylaryl group having for example 7 to about 30 carbon atoms such as toluen-α-yl; and

(g) an arylalkyl group having for example 7 to about 30 carbon atoms such as 4-ethylbenzen-1-yl and 4-sec-butylbenzen-1-yl.

3. Exemplary Examples of Substitutions on the Hydrocarbon Group and of Substituents for R₃, R₄, R₅, R₆, R₇, and R₈

The moieties described below are exemplary examples of substitutions on the hydrocarbon group (any of the hydrocarbon groups can be optionally substituted one, two, or more times with the same or different substituting moiety) and of substituents for R₃ through R₈.

(a) a nitrogen containing group such as amino, nitro, cyano, isocyano, cyanato, isocyanato, thiocyanato, and isothiocyanato;

(b) a sulfur containing group such as thiol, sulfoxide, sulfate, chlorosulfate;

(c) a hydroxyl group;

(d) a silicon containing group such as a trisubstituted silane where the substituent is a hydrocarbon;

(e) a halogen such as bromine, chlorine, fluorine, and iodine; and

(f) a hetero atom moiety, having for example 3 to about 15 atoms, and including an element selected for instance from the group consisting of nitrogen, sulfur, silicon, and oxygen, such as thiophen-2-yl, thiophen-3-yl, pyridin-2-yl, pyridin-3-yl, pyridin-4-yl, furan-2-yl, furan-3-yl and the like.

Exemplary substituted hydrocarbon groups include for instance the following: 2-hydroxyethan-1-yl, 3-hydroxypropan-1-yl, 2-methylbenzen-1-yl, 2,6-diisopropylbenzen-1-yl, 2,5-dimethylbenzen-1-yl, 4-methylnapthalen-1-yl, 5-methylnaphthalen-2-yl.

Pathway 1 below depicts an illustrative synthesis pathway to prepare the compounds of the present invention. In Pathway 1, R₁ and R₂ are shown as R in the final compound and the reagents because the depicted synthesis pathway is primarily for the situation where R₁ and R₂ are symmetrical, i.e., they are the same. However, the present disclosure also discusses the preparation of unsymmetrical compounds where R₁ and R₂ are different from each other.

The synthesis of symmetrical compounds of Formula I is accomplished by a two step process, the first involving reaction of two equivalents of primary amine with 3,3′,4,4′-benzophenone tetracarboxylic dianhydride to form an intermediate N,N′-disubstituted 3,3′,4,4′-benzophenone tetracarboxylic diimide, followed by treatment of this intermediate with malononitrile. The first step is readily accomplished by simply heating the reactants to a temperature of from about 75 to 200° C., in a solvent such as N,N-dimethylformamide. The second step, which can be carried out in a solvent such as dimethylformamide at a temperature of from about 25 to 175° C., uses a base catalyst such as pyridine or piperidine.

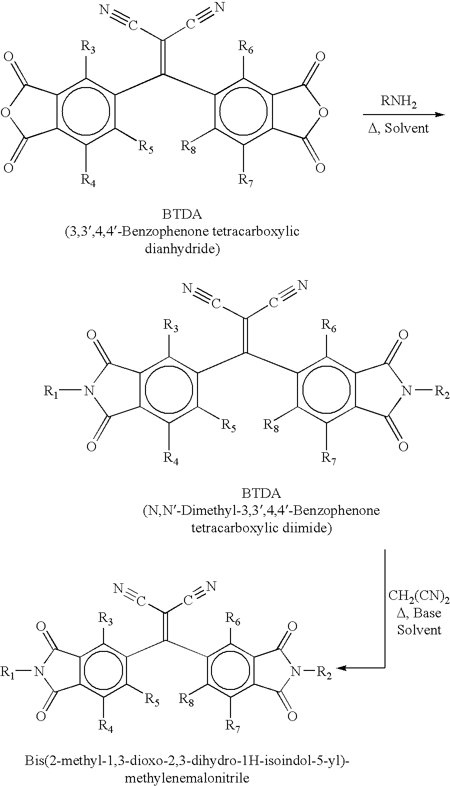

Pathway 1

If unsymmetrical benzophenone bisimide malononitrile derivatives are desired, such as for better solubility, such compounds are most easily prepared and used as a mixture with the symmetric compounds. For example a mixture can be made by reacting two different primary amines with 3,3′,4,4′-benzophenone tetracarboxylic dianhydride to form a mixture of the three possible benzophenone derivatives, followed by dicyanomethylation to give the benzophenone bisimide malononitrile derivatives. If both amines, R₁NH₂ and R₂NH₂ have similar reactivity, the mixture would be composed of 2 parts (50%) of the unsymmetrical compound, having a R₁ substituent and a R₂ substituent, and 1 part (25%) of each of the two symmetrical compounds having two R₁ substituents and two R₂ substituents as illustrated below in Pathway 2 where R₃ to R₈ are hydrogen

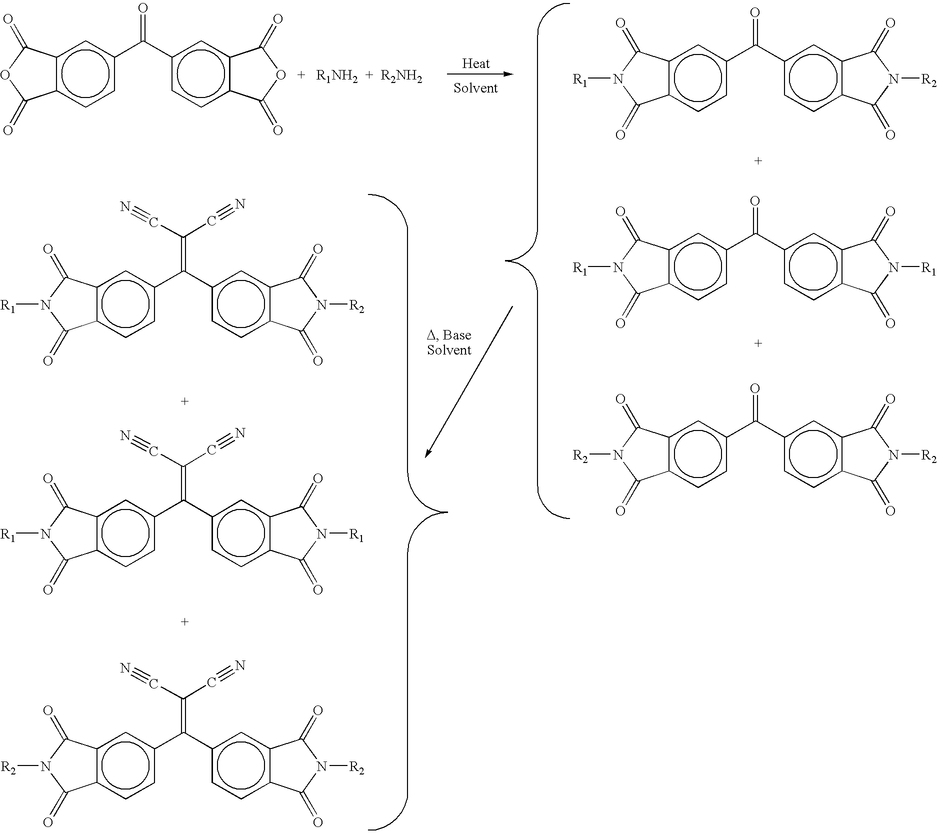

Pathway 2.

In a similar manner, the synthesis using an equal amount of three different amines with similar reactivity, R₁NH₂, R₂NH₂ and R₃NH₂, would result in the formation of 6 different compounds in the approximate ratio of 1/9^{th} part of each of the three symmetrical compounds having two R₁, two R₂ or two R₃ substituents, and 2/9^{th} parts of each of the unsymmetrical products containing R1-R2, R1-R3 and R₂-R₃ substituents. Four different amines would result in a mixture of 10 different compounds, and so on.

It will be apparent to those skilled in the art that the procedures described herein will be generally insensitive to the choice of R₃, R₄, R₅, R₆, R₇, and R₈. It will also be apparent that the introduction of R₃, R₄, R₅, R₆, R₇, and R₈ should preferentially be performed before undertaking the synthetic sequence described herein. That is, the starting materials may be changed from 3,3′,4,4′-benzophenone tetracarboxylic acid dianhydride to a material that already contains the desired substitution pattern.

It should also be apparent that for certain choices and combinations of R₃, R₄, R₅, R₆, R₇, and R₈ the synthetic procedure described herein may yield structural isomers.

The compounds of Formula I are useful as for example an electron transport agent in electrophotographic elements or other organic electronic devices.

A number of the compounds of Formula I of this invention have a minimum solubility of about 2 g in 100 mL dichloromethane (DCM) and they possess good electron transport capability in photoconductor elements.

The compounds of Formula I are not known to be carcinogenic, are stable under ambient conditions, are readily prepared, and can be compounded for utilization as an electron transport agent since such compounds may be soluble in common organic solvents, especially chlorinated solvents.

For use as an electron transport agent, a compound of Formula I may be dissolved or dispersed together with a preferably dissolved, insulating, film forming binder polymer in a solvent medium, such as a chlorinated hydrocarbon, or the like. This resulting composition can be coated on a surface and then dried to provide the desired charge transport layer.

Benzophenone bisimide malononitrile derivatives of Formula I may be soluble in embodiments to an extent of at least about 25 weight percent, or to an extent of at least about 40 weight percent, in an organic solvent which is suitable for use as a coating solvent. Exemplary solvents are, for example, tetrahydrofuran, toluene, and halogenated hydrocarbons, such as chlorobenzene, 1,2-dichloroethane, 1,1,2-trichloroethane, 1,1,2-trichloropropane, 1,1,2,2-tetrachloroethane, dichloromethane, and trichloromethane.

The photoconductor elements of this invention can have any known configuration. The photoconductor elements can have one active layer comprising both a charge generation material and an electron transport agent of Formula I, or they can be multiactive elements. The multiactive elements of this invention have at least one charge generation layer having at least one charge generation material and one charge transport layer having at least one charge transport agent of Formula I. In addition to charge generation layers and charge transport layers, the photoconductor elements of this invention may include electrically conductive layers and optional additional layers, such as subbing layers, adhesive layers, abrasion resistant layers, and electronic charge barrier layers which are all well known in the art.

It is preferred that the photoconductor elements of this invention have dimensional stability. This can be accomplished by using an electrically conductive layer that is itself dimensionally stable, or by forming the element on a dimensionally stable conductive substrate. A dimensionally stable electrically conductive layer or the combination of an electrically conductive layer and a dimensionally stable substrate will be referred to as an electrically conductive support. A dimensionally stable substrate may be thermally stable and may be electrically insulating. Conventional dimensionally stable substrates such as films and sheets of polymeric materials may be used. Examples of polymers used in films include cellulose acetate, polycarbonates, polyesters, such as poly(ethylene terephthalate) and poly(ethylene naphthalate), and polyimides. Typical film substrates have a thickness in the range of about 100 to 200 microns, although thicker and thinner layers can be employed.

The charge transport layer having at least one benzophenone bisimide malononitrile derivative of Formula I can be the top layer of the photoconductor element through which the light or activating energy passes to the charge generation layer, because the compounds of Formula I are substantially transparent to visible and near infrared region light. There will be little or no loss in incident light as such light passes through a charge transport layer of this invention. When the charge transport layer is the top layer, it provides the additional benefit of protecting the charge generation layer from abrasion caused when paper, cleaning brushes, or the like, contact the photoconductor element. These photoconductor elements of the invention are particularly useful as positively-charged photoconductor elements.

Photoconductor elements of this invention having a compound of Formula I as the electron transport agent display photosensitivity in the spectral range of for example about 400 to about 900 nm. The exact photosensitivity achieved in any given photoconductor element is dependent upon the choice of charge generation material(s), and the configuration of layer(s) in the photoconductor element. The term “photosensitivity” as used herein means the capacity of a photoconductor element to decrease in surface potential upon exposure to actinic radiation. For purposes of the present invention, photosensitivity is conveniently measured by corona charging the element to a certain potential, exposing the charged element to a monochromatic light and measuring the decrease of the surface potential. The amount of light necessary to discharge the element to a certain potential is defined as the “exposure requirement” for that potential. The exposure requirement to discharge the photoconductor element to half of its initial value is denoted E_{0 5}.

The photoconductor elements of this invention can employ various electrically conductive layers. For example, the conductive layer can be a metal foil which is laminated to the substrate. Suitable metal foils include those comprised of aluminum, zinc, copper, and the like. Alternatively, vacuum deposited metal layers upon a substrate are suitable and are presently preferred, such as vapor deposited silver, nickel, gold, aluminum, chromium, and metal alloys. The thickness of a vapor deposited metal layer can be in the range of about 20 to about 500 angstroms. Conductive layers can also comprise a particulate or dissolved organic or inorganic conductor or semiconductor distributed in a binder resin. For example, a conductive layer can comprise compositions of protective inorganic oxide and about 30 to about 70 weight percent of conductive metal particles, such as a vapor deposited conductive cermet layer as described in U.S. Pat. No. 3,880,657. Also see in this connection the teachings of U.S. Pat. No. 3,245,833 relating to conductive layers employed with barrier layers. Organic conductive layers can be employed, such as those comprised of a sodium salt of a carboxyester lactone of maleic anhydride in a vinyl acetate polymer, as taught, for example in U.S. Pat. Nos. 3,007,901 and 3,262,807. The substrate and the conductive layer can also be formulated as a consolidated layer which can be a metal plate or drum. For example, suitable plates or drums can be formed of metals such as aluminum, copper, zinc, brass and steel.

In the photoconductor elements of the invention, the conductive layer is optionally overcoated by a barrier adhesive or subbing layer. The barrier layer typically has a dry thickness in the range of about 0.01 to about 5 microns. Typical subbing layers are solvent soluble, film-forming polymers, such as, for example, cellulose nitrate, nylon, polyesters, copolymers of poly(vinyl pyrrolidone) and vinylacetate, and various vinylidene chloride-containing polymers. Preferred subbing layers are comprised of nylon, and polyacrylic and methacrylic esters. The barrier layer coating composition can also contain minor amounts of various optional additives, such as surfactants, levelers, plasticizers, and the like.

While any convenient method of application of a subbing layer can be used, it is presently preferred to dissolve the polymer in a solvent, and then to coat the solution over the conductive layer.

Preferably, the solvents are volatile, that is evaporable, at temperatures below about 150 degrees C. Examples of suitable solvents include petroleum ethers; aromatic hydrocarbons, such as benzene, toluene, xylene, and mesitylene; ketones, such as acetone, and 2-butanone; ethers, such as tetrahydrofuran and diethyl ether; alkanols, such as isopropyl alcohol; and halogenated aliphatic hydrocarbons, such as methylene chloride, chloroform, and ethylene chloride. Coating solvents include for example chlorinated aliphatic hydrocarbons. A nylon subbing layer may be coated from an alcohol. Mixtures of different solvents or liquids can also be employed.

The barrier layer coating composition is applied by using a technique such as knife coating, spray coating, spin coating, extrusion hopper coating, curtain coating, or the like. After application, the coating composition is conveniently air dried.

In addition to organic polymers, inorganic materials can be utilized for the formation of barrier layers. Silicon dioxide, for example, can be applied to a conductive support by vacuum deposition.

The charge generation layer is applied over the conductive layer, or over the barrier layer, if a barrier layer is employed.

The charge generating (or generation) layer is conveniently comprised of at least one conventional charge generation material that is typically dispersed in a polymeric binder. The layer can have a thickness that varies over a wide range, typical layer thicknesses being in the range of about 0.05 to about 5 microns. As those skilled in the art will appreciate, as layer thickness increases, a greater proportion of incident radiation is absorbed by a layer, but the likelihood increases of trapping a charge carrier which then does not contribute to image formation. Thus, an optimum thickness of a layer can constitute a balance between these competing influences.

Charge generation materials comprise materials that are capable of generating electron/hole pairs upon exposure to actinic radiation in the presence of an electric field and transferring the electrons to an electron-transport agent. The charge generation material is present in a polymeric binder or is present as a separate solid phase. The process by which electron/hole pairs are generated may require the presence of an electron-transport agent. Suitable charge generation materials may be in embodiments substantially incapable of generating and/or transferring electrons/hole pairs to an electron-transport agent in the absence of actinic radiation.

A wide variety of materials known in the art as charge generation materials can be employed including inorganic and organic compounds. Suitable inorganic compounds include, for example, zinc oxide, lead oxide, and selenium. Suitable organic materials include various particulate organic pigment materials, such as phthalocyanine pigments, and a wide variety of soluble organic compounds including metallo-organic and polymeric organic charge generation materials. A partial listing of representative materials may be found, for example, in Research Disclosure, Vol. 109, May, 1973, page 61, in an article entitled “Electrophotographic Elements, Materials and Processes”, at paragraph IV(A) thereof. This partial listing of well-known charge generation materials is hereby incorporated by reference.

Examples of suitable organic charge generation materials include phthalocyanine pigments such as a bromoindium phthalocyanine pigment described in U.S. Pat. Nos. 4,666,802 and 4,727,139 or a titanylphthalocyanine pigment such as a titanyl tetrafluoropthalocyanine described in U.S. Pat. No. 4,701,396; various pyrylium dye salts, such as pyrylium, bispyrylium, thiapyrylium, and selenapyrylium dye salts, as disclosed, for example, in U.S. Pat. No. 3,250,615; fluorenes, such as 7,12-dioxo-13-dibenzo(a,h) fluorene, and the like; aromatic nitro compounds of the kind disclosed in U.S. Pat. No. 2,610,120; anthrones such as those disclosed in U.S. Pat. No. 2,670,284; quinones such as those disclosed in U.S. Pat. No. 2,670,286; thiazoles, such as those disclosed in U.S. Pat. No. 3,732,301; various dyes such as cyanine (including carbocyanine), merocyanine, triarylmethane, thiazine, azine, oxazine, xanthene, phthalein, acridine, azo, anthraquinone dyes, and the like, and mixtures thereof.

The charge generation material, or a mixture of charge generation materials, is usually applied from a solution or dispersion in a coating composition to form a charge generating layer in an element over a barrier layer of the type described herein. Also typically present as dissolved solids in a charge generation layer coating composition are a binder polymer and optional additives, such as surfactants, levelers, plasticizers, sensitizers, and the like. The solids comprising a charge generation layer on a 100 weight percent total basis typically comprise 1 to about 70 weight percent of charge-generation material, 0 to about 99 weight percent of polymeric binder, and 0 to about 50 weight percent of total additives. In embodiments, the coating composition contains from about 6 to about 15 weight percent of solids, the balance being solvent. Suitable solvents are those identified above in relation to the barrier layer. In embodiments, additives for a composition to be coated to form a charge generation layer are charge transport agents and surfactants.

Any hydrophobic organic polymer known to the photoconductor element art as a binder can be used for the polymeric binder in the charge generating layer. These polymers are film forming and are preferably organic solvent soluble, and, in solid form, display high dielectric strength and electrical insulating properties. Suitable polymers include, for example, styrene-butadiene copolymers; polyvinyl toluene-styrene copolymers; silicone resins, styrene alkyd resins, silicone-alkyd resins; soya-alkyd resins; poly(vinyl chloride); poly(vinylidene chloride); vinylidene chloride-acrylonitrile copolymers; poly(vinyl acetate); vinyl acetate-vinyl chloride copolymers; poly(vinyl acetate); vinyl acetate-vinyl chloride copolymers; poly(vinyl acetals), such as poly(vinyl butyral); polyacrylic and methacrylic esters, such as poly(methyl methacrylate), poly(n-butyl methacrylate), poly(isobutyl methacrylate), etc.; polystyrene, nitrated polystyrene; polymethylstyrene; isobutylene polymers; polyesters, such as poly[4,4′-(2-norbomylidene)bisphenylene azelate-co-terephthalate(60/40)], and poly[ethylene-co-alkylene-bis(alkylene-oxyaryl)-phenylenedicarboxylate]; phenolformaldehyde resins; ketone resins; polyamides; polycarbonates; polythiocarbonates; poly[ethylene-co-isopropylidene-2,2-bis(ethyleneoxyphenylene)terephthalate]; copolymers of vinyl haloarylates and vinyl acetate, such as poly(vinyl-m-bromobenzoate-co-vinyl acetate); chlorinated polyolefins such as chlorinated polyethylene; and the like. Preferred polymers are polyesters and polycarbonates.

A charge generating layer composition is applied by coating the composition over the barrier layer using a technique such as above described for coating a barrier layer composition. After coating, the charge generating layer composition is usually air dried.

Instead of a charge generation material being dispersed in a polymeric binder, a charge generation layer can, in some cases, depending upon the charge generation material involved, be comprised substantially entirely of only such a material. For example, a perylene dicarboximide pigment of the Formula in column 11, line 45, of U.S. Pat. No. 5,468,583, wherein R is an aryl or arylalkylenyl group, can be applied over an electrically conductive layer under vacuum by sublimination, such as under subatmospheric pressures of about 10⁻² to about 10⁻⁵ mm Hg at temperatures in the range of about 200 degrees C to about 400 degrees C.

An illustrative charge generation material comprises titanylphthalocyanine or titanyl tetrafluorophthalocyanine pigment described in U.S. Pat. No. 4,701,396 incorporated herein by reference. An illustrative binder in the charge generating layer is poly [4,4′-(2-norbomylidene)bisphenylene azelate-co-terephthalate(60/40)].

The charge transport layer is applied over the charge generation layer. When the charge transport layer contains at least one compound of Formula I, an electron-transporting charge transport layer is produced.

A charge transport layer, if desired, can contain, in addition to at least one compound of Formula I, at least one additional electron transport agent of a type known to the art. Suitable known electron transport agents include 2,4,7-trinitro-9-fluorenone, substituted 4-dicyanomethylene-4H-thiopyran 1,1-dioxides, and substituted anthraquinone biscyanoimines.

In the charge transport layer, the charge transport agent(s) are dispersed, and may be dissolved, in an electrically insulating organic polymeric film forming binder. In general, any of the polymeric binders useful in the photoconductor element art can be used, such as described above for use in a charge generation layer. Additionally, the charge transport layer of this invention can utilize a polymeric binder which itself is a charge transport agent. Examples of such polymeric binders include poly(vinylcarbazole). Exemplary binders include polycarbonates such as bisphenol A polycarbonate, bisphenol Z polycarbonate, and polyesters such as poly[4,4′-(2-norbornylidene)bisphenylene azelate-co-terephthalate(60/40)].

On a 100 weight percent total solids basis, a charge transport layer comprises for example about 10 to 70 weight percent of at least one Formula I compound and about 30 to about 90 weight percent of binder. Typically, a charge transport layer has a thickness in the range of about 10 to about 25 microns, although thicker and thinner layers can be employed.

One or more other electron transporting agents may be used with the present inventive compounds in photoconductor elements and other electronic devices. Examples of such other electron transporting agents include:

1. A Carboxlfluorenone malonitrile (CFM) derivatives represented by the general structure:

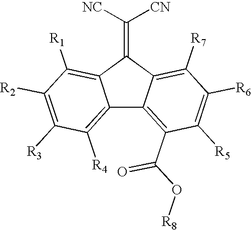

wherein each R is independently selected from the group consisting of hydrogen, alkyl having 1 to 40 carbon atoms, alkoxy having 1 to 40 carbon atoms, phenyl, substituted phenyl, higher aromatic such as naphthalene and anthracene, alkylphenyl having 6 to 40 carbon atoms, alkoxyphenyl having 6 to 40 carbon atoms, aryl having 6 to 30 carbon atoms, substituted aryl having 6 to 30 carbon atoms and halogen.

2. A nitrated fluoreneone derivative represented by the general structure:

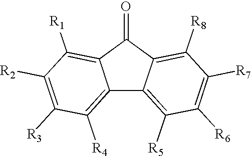

wherein each R is independently selected from the group consisting of hydrogen, alkyl having 1 to 40 carbon atoms, alkoxy having 1 to 40 carbon atoms, phenyl, substituted phenyl, higher aromatic such as naphthalene and anthracene, alkylphenyl having 6 to 40 carbon atoms, alkoxyphenyl having 6 to 40 carbon atoms, aryl having 6 to 30 carbon atoms, substituted aryl having 6 to 30 carbon atoms and halogen, and at least 2 R groups are chosen to be nitro groups.

3. A N,N′bis(dialkyl)-1,4,5,8-naphthalenetetracarboxylic diumide derivative or N,N′bis(diaryl)-1,4,5,8-naphthalenetetracarboxylic diimide derivative represented by the general structure:

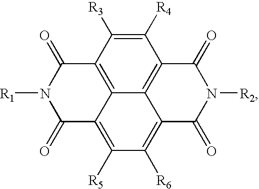

wherein R₁ is substituted or unsubstituted alkyl, branched alkyl, cycloalkyl, alkoxy or aryl, such as phenyl, naphthyl, or a higher polycyclic aromatic such as anthracene R₂ is alkyl, branched alkyl, cycloalkyl, or aryl, such as phenyl, naphthyl, or a higher polycyclic aromatic such as anthracene or the same as R₁; R₁ and R₂ can be chosen independently to have total carbon number between 1 and 50 but is preferred to be between 1 and 12. R₃, R₄, R₅ and R₆ are alkyl, branched alkyl, cycloalkyl, alkoxy or aryl, such as phenyl, naphthyl, or a higher polycyclic aromatic such as anthracene or halogen and the like. R₃, R₄, R₅ and R₆ can be the same or different. In the case where R₃, R₄, R₅ and R₆ are carbon, they can be chosen independently to have a total carbon number between 1 and 50 but is preferred to be between 1 and 12.

4. A 1,1′-dioxo-2-(aryl)-6-phenyl-4-(dicyanomethylidene)thiopyran derivative represented by the general structure:

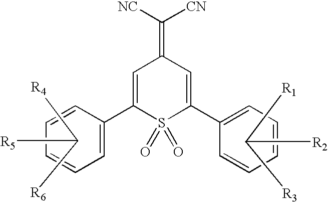

wherein each R is independently selected from the group consisting of hydrogen, alkyl having 1 to 40 carbon atoms, alkoxy having 1 to 40 carbon atoms, phenyl, substituted phenyl, higher aromatic such as naphthalene and anthracene, alkylphenyl having 6 to 40-carbon atoms, alkoxyphenyl having 6 to 40 carbon atoms, aryl having 6 to 30 carbon atoms, substituted aryl having 6 to 30 carbon atoms and halogen.

5. A carboxybenzylnaphthaquinone derivative represented by the following general structure:

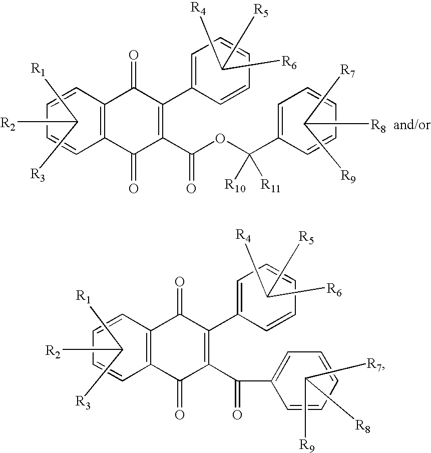

wherein each R is independently selected from the group consisting of hydrogen, alkyl having 1 to 40 carbon atoms, alkoxy having 1 to 40 carbon atoms, phenyl, substituted phenyl, higher aromatic such as naphthalene and anthracene, alkylphenyl having 6 to 40 carbon atoms, alkoxyphenyl having 6 to 40 carbon atoms, aryl having 6 to 30 carbon atoms, substituted aryl having 6 to 30 carbon atoms and halogen.

6. A diphenoquinone represented by the following general structure:

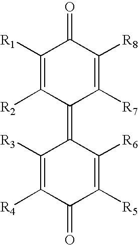

and mixtures thereof, wherein each R is independently selected from the group consisting of hydrogen, alkyl having 1 to 40 carbon atoms, alkoxy having 1 to 40 carbon atoms, phenyl, substituted phenyl, higher aromatic such as naphthalene and anthracene, alkylphenyl having 6 to 40 carbon atoms, alkoxyphenyl having 6 to 40 carbon atoms, aryl having 6 to 30 carbon atoms, substituted aryl having 6 to 30 carbon atoms and halogen.

In addition to an electron transport agent of Formula I, and optionally additional charge transport agent(s) and a binder polymer, the charge transport layers in the photoconductor elements of this invention may contain various optional additives, such as surfactants, levelers, plasticizers, and the like. On a 100 weight percent total solids basis, a charge transport layer can contain for example up to about 15 weight percent of such additives, although it may contain less than about 1 weight percent of such additives.

In embodiments, the charge transport layer solid components are conveniently preliminarily dissolved in a solvent to produce a charge transport layer composition containing for example about 8 to about 20 weight percent solids with the balance up to 100 weight percent being the solvent. The solvents used can be those hereinabove described.

Coating of the charge transport layer composition over the charge generation layer can be accomplished using a solution coating technique such as knife coating, spray coating, spin coating, extrusion hopper coating, curtain coating, dip coating, and the like. After coating, the charge transport layer composition is usually air dried.

A charge transport layer can be formed of two or more successive layers each of which has the same or different total solids composition. In such event at least one charge transport sublayer contains at least one compound of Formula I.

Photoconductor elements of this invention may display dark decay values of for example no more than about 20 V/sec, or no more than about 5 V/sec. The term “dark decay” as used herein means the loss of electric charge and consequently, electrostatic surface potential from a charged photoconductor element in the absence of activating radiation.

For present purposes of measuring dark decay, a single-active-layer photoconductive element or a multilayered photoconductor element is charged by use of a corona discharge device to a surface potential in the range of about +300 to about +600 volts. Thereafter, the rate of charge dissipation and decrease of surface potential in volts per second is measured. The element is preliminarily dark adapted and maintained in the dark without activating radiation during the evaluation using ambient conditions of temperature and pressure.

Preferred photoconductor elements of this invention display reusability, that is, the ability to undergo repeated cycles of charging and discharging without substantial alteration of their electrical properties.

Those skilled in the art will appreciate that other variations in the structure of photoconductor elements incorporating a compound of Formula I are possible and practical. For example, various different layer arrangements can be employed. Thus, a transport layer can be positioned between two charge generation layers which can have the same or different respective compositions and layer thicknesses. Also, a charge generation layer can be positioned between two charge-transport layers only one of which may contain a compound of Formula I.

The invention will now be described in detail with respect to specific embodiments thereof, it being understood that these examples are intended to be illustrative only and the invention is not intended to be limited to the materials, conditions, or process parameters recited herein. All percentages and parts are by weight unless otherwise indicated.

### EXAMPLE 1

N,N′-Bis(3-methoxypropyl)-3,3′,4,4′-benzophenone Tetracarboxylic Diimide.

Benzophenone tetracarboxylic dianhydride (64.4 g, 20 mole), available from Criskev Company, Inc. (5109 W. 111^{th} Terrace, Leawood, Kans. 66211-1742) in 300 ml of dimethylformamide was treated with 3-methoxypropylamine (42.8 mL, 0.42 mole). The mixture was stirred at room temperature for 15 min then was heated to reflux (about 154° C.) for 1 hour. The clear yellow-brown solution was cooled to room temperature and methanol (600 mL) was added with vigorous stirring. The resultant suspension was stirred at room temperature for 2 h then was filtered by suction. The solid was washed in the filter funnel with 4×59 mL portions of methanol and was dried at 60° C. overnight to give the required product which was a cream colored solid, (58.8 g, 63% yield) The purity was estimated to be greater than 99% by proton magnetic resonance spectroscopy.

A similar procedure was used to prepare the other N,N′-disubstituted benzophenone bisimides shown in Table 1.

TABLE 1
N,N'-Disubstituted-3,3',4,4'-benzophenone Tetracarboxylic Diimides.

| R₁, R₂ = | Yield (%) | m.p. (° C. DSC) |
|---|---|---|
| H | 58 | >395 |
| Ethyl | 76 | 164 |
| i-propyl | 70 | 209 |
| n-butyl | 43 | 149 |
| -butyl | 75 | 199 |
| 1,2-dimethylpropyl | 51 | 241 |
| n-hexyl | 78 | 139 |
| Cyclohexyl | 74 | 321 |
| 2-ethylhexyl | 82 | 100 |
| 3-methoxypropyl | 63 | 127 |
| p-methylphenyl | 91 | 371 |
| Phenethyl | 82 | 252 |
| methyl | 78 | 233 |
| p-n-butylphenyl | 52 | 334 |
| sec-butyl | 64 | 193 |
| 2-pyridyl | 90 | 331 |

### EXAMPLE 2

N,N′-Bis(sec-butyl)Benzophenone Bisimide-Malononitrile Derivative, Formula I where R₁═R₂=sec-butyl and R₃—R₈═H (IUPAC Name: (Bis(2-secbutyl-1,3-dioxo-2,3-dihydro-1H-isoindol-5-yl)methylene)malononitrile).

N,N′-Bis(sec-butyl)-3,3′,4,4′-benzophenone tetracarboxyic diimide (Table 1; 48.18 g, 0.50 mole) and malononitrile were dissolved in 180 mL of dimethylformamide. Pyridine (20 mL, 0.25 mole) was added and the solution was heated at 100° C. for 4 h, when a sample analyzed by reverse-phase high performance liquid chromatography indicated that conversion to the malononitrile derivative was complete. The solution was cooled to room temperature and the product was precipitated by addition of methanol (600 mL) to the vigorously-stirred solution. The precipitate was filtered and was washed with 5×50 mL portions of methanol. Drying at 60° C. gave the derivative as a white powder (35.7 g, 75% yield). The purity was judged to be greater than 9% by proton NMR.

A similar procedure was used to prepare the other malononitrile derivatives shown in Table 2.

TABLE 2
Benzophenone Diimide Malonitrile Derivatives.

| R₁, R₂ = | Yield (%) | m.p. (° C., DSC) |
|---|---|---|
| Ethyl | 95 | 269 |
| i-propyl | 72 | 149 |
| n-butyl | 70 | 170 |
| -butyl | 95 | 208 |
| 1,2-dimethylpropyl | 50 | 250 |
| n-hexyl | 92 | 134 |
| cyclohexyl | 66 | 238 |
| 2-ethylhexyl | 54 | 112 |
| 3-methoxypropyl 99 | 168 | |
| phenethyl | 85 | 177 |
| methyl | 95 | 269 |
| sec-butyl | 75 | 228 |

We claim:

1. A compound having the Formula I 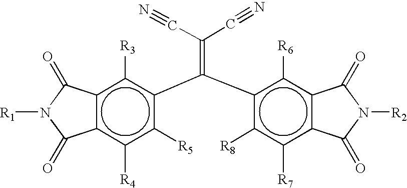
wherein:
R₁ and R₂ are independently selected from the group consisting of hydrogen, a hetero atom containing group and a hydrocarbon group that is optionally substituted at least once with a hetero atom moiety; and
R₃, R₄, R₅, R₆, R₇, and R₈ are independently selected from the group consisting of a nitrogen containing group, a sulfur containing group, a hydroxyl group, a silicon containing group, hydrogen, a halogen, a hetero atom containing group and a hydrocarbon group that is optionally substituted at least once with a hetero atom moiety.

2. The compound of claim 1 wherein:
R₃, R₄, R₅, R₆, R₇, and R₈ are hydrogen.

3. The compound of claim 1 wherein:
R₁ and R₂ are the same; and
R₃, R₄, R₅, R₆, R₇, and R₈ are hydrogen.

4. The compound of claim 1 wherein:
R₁ and R₂ are the same; and
R₄, R₅, R₆, R₇, and R₈ are the same but different from R₁ and R₂.

5. The compound of claim 1 wherein:
R₁ and R₂ are independently selected from a straight chain alkyl group and a branched alkyl group; and
R₃, R₄, R₅, R₆, R₇, and R₈ are hydrogen.

6. The compound of claim 1 wherein:
R₁ and R₂ are the same and are selected from the group consisting of 1-methylhexan-1-yl and 1,6-dimethylhexan-1-yl; and
R₃, R₄, R₅, R₆, R₇, and R₈ are hydrogen.

7. A photoconductor element comprising: a charge generation material and an electron transport agent, wherein the electron transport agent includes a compound having the Formula I of claim 1.

8. A photoconductor element comprising:
an electrically conductive layer; and
a layer comprising a binder, a charge generation material, and an electron transport agent including a compound having the Formula I of claim 1.

9. A compound having the Formula I 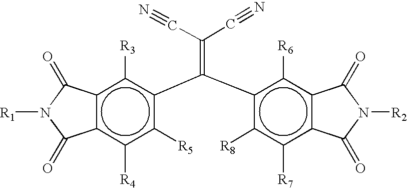
wherein:
R₁ and R₂ are independently selected from the group consisting of a straight chain alkyl group, a branched alkyl group, a cycloalkyl group, an alkoxy group, a monocyclic aromatic group, a polycyclic aromatic group, a heterocyclic group, an alkylaryl group, an arylalkyl group, an alkoxyaryl group, an arylalkoxy group, and hydrogen; and
R₃, R₄, R₅, R₆, R₇, and R₈ are independently selected from the group consisting of a straight chain alkyl group, a branched alkyl group, a cycloalkyl group, an alkoxy group, a monocyclic aromatic group, a polycyclic aromatic group, an alkylaryl group, an arylalkyl group, an alkoxyaryl group, an arylalkoxy group, an aryloxy group, a halogen, and hydrogen.

10. The compound of claim 9 wherein:
R₃, R₄, R₅, R₆, R₇, and R₈ are hydrogen.

11. The compound of claim 9 wherein:
R₁ and R₂ are the same; and
R₃, R₄, R₅, R₆, R₇, and R₈ are hydrogen.

12. The compound of claim 9 wherein:
R₁ and R₂ are the same; and
R₃, R₄, R₅, R₆, R₇, and R₈ are the same but different from R₂ and R₃.

13. The compound of claim 9 wherein:
R₁ and R₂ are independently selected from the straight chain alkyl group and the branched alkyl group; and
R₃, R₄, R₅, R₆, R₇, and R₈ are hydrogen.

14. The compound of claim 9 wherein:
R₁ and R₂ are the same and are selected from the group consisting of 1-methylhexan-1-yl and 1,6-dimethylhexan-1-yl; and
R₃, R₄, R₅, R₆, R₇, and R₈ are hydrogen.

15. A photoconductor element comprising: a charge generation material and an electron transport agent, wherein the electron transport agent includes a compound having the Formula I of claim 9.

16. A photoconductor element comprising:
an electrically conductive layer; and
a layer comprising a binder, a charge generation material, and an electron transport agent including a compound having the Formula I of claim 9.
